(19) United States
(12) Patent Application Publication
(10) Pub. No.: US 2018/0133859 A1
(43) Pub. Date: May 17, 2018

(54) WEAR-INDICATING BLADE

(71) Applicant: Thomas Jay Landwehr, DePere, WI (US)

(72) Inventor: Thomas Jay Landwehr, DePere, WI (US)

(21) Appl. No.: 15/353,858

(22) Filed: Nov. 17, 2016

(51) Int. Cl. B23Q 17/09; B23Q 17/24; B26D 1/00

(52) U.S. Cl. CPC B23Q 17/0995; B23Q 17/2457; F04D 29/38; B26D 2001/002; B26D 1/0006

(57) ABSTRACT

A cutting blade partially covered with one or more layers covering a part of the blade, with one of the layers being a wear layer which has a different visual appearance than the underlying material of the blade, and wears away more quickly than the core material when the blade is used, so that the underlying material of the blade is uncovered as soon as this wear layer is completely removed in partial areas, providing a clear visual signal that it needs to be replaced.

### FIELD OF THE INVENTION

The present invention relates to a blade with wear indicating means.

### BACKGROUND OF THE INVENTION

Blades, be it for propellers on aircrafts, boats, in pumps or for all sorts of scraping and cutting tools, all owe their efficiency to a particular geometry. For instance, the blades used to propel fluids must feature a sharp edge for cutting through the fluid without effort and a smooth surface to minimize frictions. Besides, functional cutting and scraping blades obviously require a sharp edge. However, the lifetime of a blade subjected to intensive use may not exceed a few hours until it becomes unsuitably worn out. The progressive erosion of the sharp edge of the blade is due to the repetitive friction against the object to cut, to scrape or the fluid to propel. A blunt blade represents a waste of time and energy, since more force and more time are required to achieve the same result. In addition, the blade does not wear out uniformly, which may result in a dented and rough cutting edge. For example, cavitation is a significant cause of erosion on the sides of propelling blades for liquids. A dented blade has disastrous consequences: instead of a clean cut, the material in the way of a cutting or scraping blade may be torn out. Similarly, a dented propelling blade may generate chaotic turbulences rather than a strong laminar flow. Eventually, the blade cannot be used any more and it has to be discarded.

For the sake of simplicity, the following introduction and description shall focus on blades for cutting, scraping and the like. It will be appreciated, though, that other types of blades, e.g. propelling blades for fluids, face similar problems. Thus, it is obvious to any person skilled in the art to apply the solution described herein to these other types of blades.

In the context of a hand-held cutting tool, dull blades not only slow down or compromise the quality of the cutting process. The extra force required for cutting also intensifies the strain in the user's hand and arm and may cause musculoskeletal disorders, more commonly known as Repetitive Strain Injuries (RSI). RSI are classified as occupational diseases in most developed countries. Besides, the additional force exerted on the material during the cut increases the risk of slipping and the severity of the probable resulting injury. Therefore, it is a matter of prime concern to monitor the sharpness of the blade's cutting edge in order to identify the stage at which it should be deemed unsuitable for cutting. Alas, the sharpness of the blade declines gradually and it is hard for the user to determine when the blade or knife should be replaced. Besides, a visually unaltered cutting edge doesn't necessarily mean that the blade isn't unsuitably sharp.

US 2014/0182144 discloses a cutting blade whose visual appearance changes when it is used. The metallic blade is coated with a colored indicator which wears away during the use of the blade by abrasion against the object to cut. So, the disappearance of the indicator provides a clear signal that the blade has worn out. The indicator layer is meant to have a poor wear resistance, in order to wear away upon the first use of the blade. Therefore, this allows the user to distinguish a brand-new blade from a used one. However, blades are not necessarily dull after the first use. This method therefore doesn't allow the user to detect the wear level, which ideally indicates the precise moment when the blade should be deemed unsuitably dull for the intended use.

EP 0499215 discloses a surface coated with an indicator layer which isn't completely worn away upon the first use of the object, but only much later, when the core material has worn out as well. This is achieved with an indicator layer whose wear resistance is at least as high as the one of the core material. However, the object only changes color when the surface has already worn out to a certain extent and lost its properties (smoothness, regularity). Thus, this invention also fails to signal the precise moment when the object should be deemed unsuitably dull for the intended use, e.g. when the cutting edge of a blade gets dull. Indeed, cutting edges are so sharp that it is impossible to identify their visual appearance or color with the naked eye. Therefore, the change of appearance of the blade will only be visible on the sides of the blade. However, the cutting force is transmitted from the blade to the material to cut via the cutting edge, which is therefore subjected to much more intense abrasion than the sides of the blade. So, if the wear layer located on the sides of the blade has the same wear resistance as the core material forming the cutting edge, it will wear away much slower and it may fail to signal the precise moment when the blade should be discarded.

Of course, even if the wear layer has the same wear resistance as the core material of the blade, one could resolve the above-mentioned issue by making the wear layer thinner. Alas, this raises difficulties specific to the deposition of very thin layers. Let's take the following example:
the blade should be deemed dull after 50 μm of material is worn away from its cutting edge;
the wear layer has the same wear resistance as the core material of the blade;
the abrasion on the sides of the blade is 10 times less intense then on the cutting edge.

Then, in order to have the wear layer disappearing totally from the sides of the blade when 50 μm of material is worn away from its cutting edge, the wear layer should be 5 μm thick. Depositing such thin layers with a uniform and accurate thickness is difficult and costly. What's more, even if the coating technique allows the deposition of layers with an outstanding accuracy of ±1 μm, this would still cause variations of thickness of ±20% on a 5-μm-thick layer. Thus, the amount of time the wear layer takes to disappear completely is only determined with a 20% precision. So, taking the example of a blade which gets dull after approximately 5 days of intensive use, the visual appearance of the blade may change one entire day too early or too late, either leaving the user with a blunt blade, or advising to discard a blade which is still suitably sharp.

### SUMMARY OF THE INVENTION

The main object of the present invention is to provide a blade whose visual appearance changes under the effect of wear. The change of visual appearance occurs as soon as the initial geometry is changed by abrasion, providing a clear visual signal that it needs to be replaced.

### BRIEF DESCRIPTION OF THE DRAWINGS

In the drawings:

FIG. 1a: Lateral view of a blade coated with the wear layer, completely coated

FIG. 1b: Lateral view of a blade coated with the wear layer, coating partially removed

FIG. 1c: Lateral view of a blade coated with the wear layer, coating completely removed in some areas

FIG. 2a: Cross section of the surface of the blade, initial state

FIG. 2b: Cross section of the surface of the blade, effect of the wear on the wear layer

FIG. 2c: Cross section of the surface of the blade, local total removal of the wear layer and emergence of the underlying material

FIG. 3a: Cross section of the edge, initial state

FIG. 3b: Cross section of the edge, effect of an insufficient wear resistance of the wear layer

FIG. 4a: Cross section of the edge, initial state

FIG. 4b: Cross section of the edge, effect of an excessive wear resistance of the wear layer

FIG. 5a: Cross section of the edge, initial state

FIG. 5b: Cross section of the edge, effect of a suitable wear resistance of the wear layer

FIG. 6: Cross section of the surface of the blade with a bonding layer and a wear layer

FIG. 7: Cross section of the surface of the blade with two wear layers

FIG. 8: Cross section of the surface of the blade with more than two wear layers

FIG. 9: Cross section of the surface of the blade with holes filled with the wear layer material

FIG. 10: Cross section of the surface of the blade with a groove filled with the wear layer material

### DETAILED DESCRIPTION OF THE INVENTION

Preferred embodiments of the blade are described according to the drawings. These preferred embodiments are to be understood as exemplary embodiments and any detailed description shall not be interpreted as limiting. In particular, the present blade may be used for any purpose, be it for cutting or scraping or propelling fluids, for example in pumps, on boats or on aircrafts. Alternate embodiments obvious to one skilled in the art will not be described in detail or will be omitted to prevent the relevant details of the invention to be overlooked.

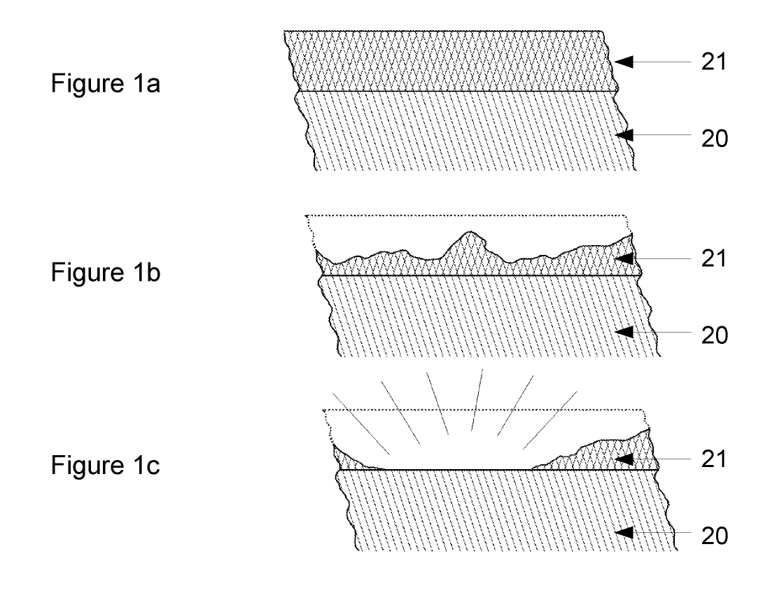

The blade is made of a metallic or ceramic core material 20. A wear layer 21 is located on top of the blade, thus concealing the underlying core material from the view of the user (FIG. 1a). During the use of the blade, material is removed from the wear layer by the abrasion against the object to cut (FIG. 1b). So, the wear layer 21 progressively gets thinner until it is entirely removed at least locally, exposing the underlying core material (FIG. 1c). The core material and the wear layer have distinct visual appearances, e.g. different colors. During the abrasion of the wear layer (FIG. 1a-b), the blade retains substantially the same visual appearance because the nature of the material exposed is the same. However, the emergence of the core material after a relevant amount of use causes a change of the visual appearance of the blade (FIG. 1c). For example, if the core material is red and the wear layer is gray, the emergence of the red color signals that the wear layer has worn out completely in some areas. In special embodiments, it may be important that the change of visual appearance of the blade is the most radical and obvious possible for the user, e.g. having the blade turning into an unusual and therefore unexpected appearance. For example, if the user is provided with a vividly colored blade which progressively turns grayish when the cutting edge gets dull, he may not even notice the change since grayish is precisely how blades are usually expected to look like. A more obvious signal is provided by new blades looking exactly like regular blades, and turning into an unusual color when they need to be replaced.

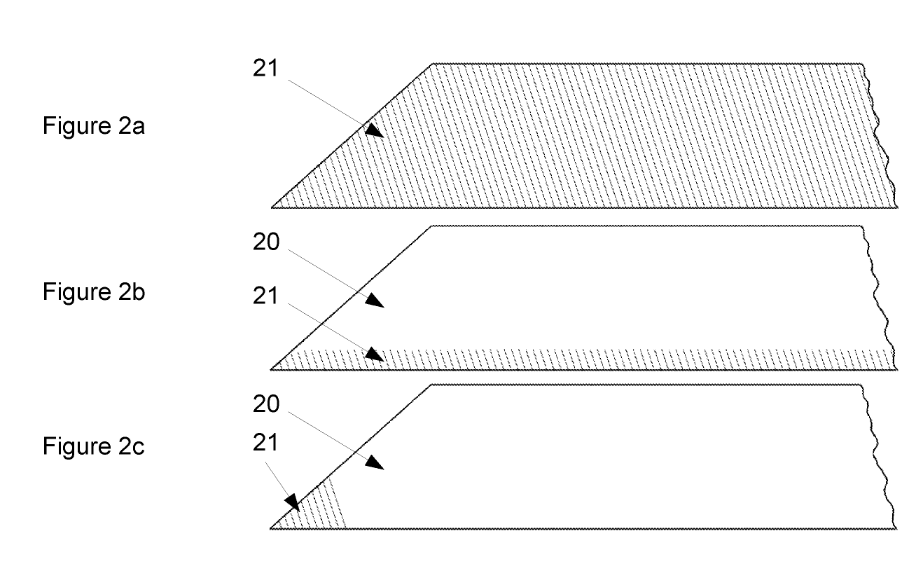

This principle can be used to monitor the gradual erosion of the blade either on its whole surface or in areas of particular interest. So, the wear layer may be applied on the whole surface of the blade (FIG. 2a) or only locally, in the vicinity of the cutting edge (FIG. 2b) or of the blade tip (FIG. 2c) for example. In addition, the thickness of the wear layer may vary according to the area in which it is applied: it may be thinner in order to wear away faster in areas where the erosion has critical effects, or thicker in other less important places.

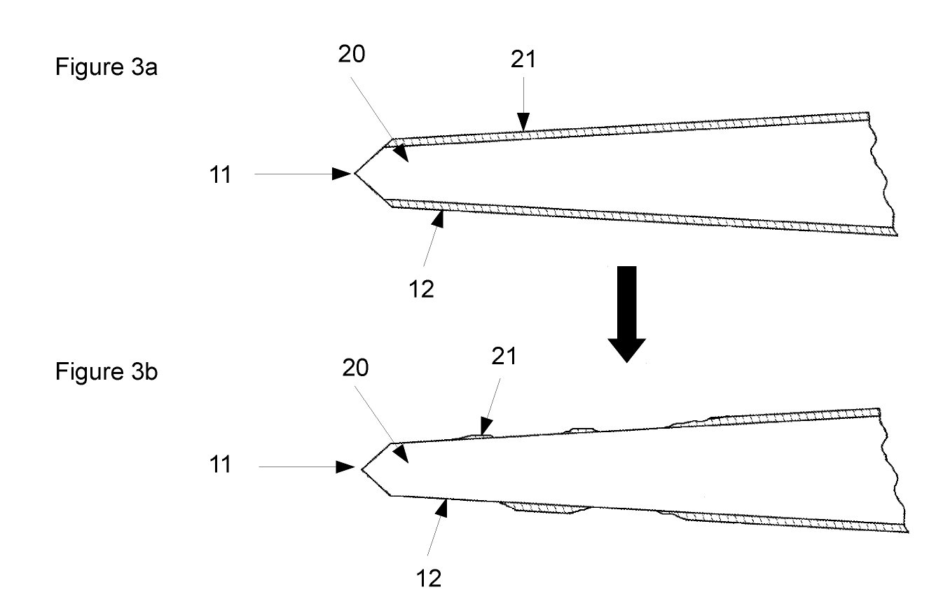

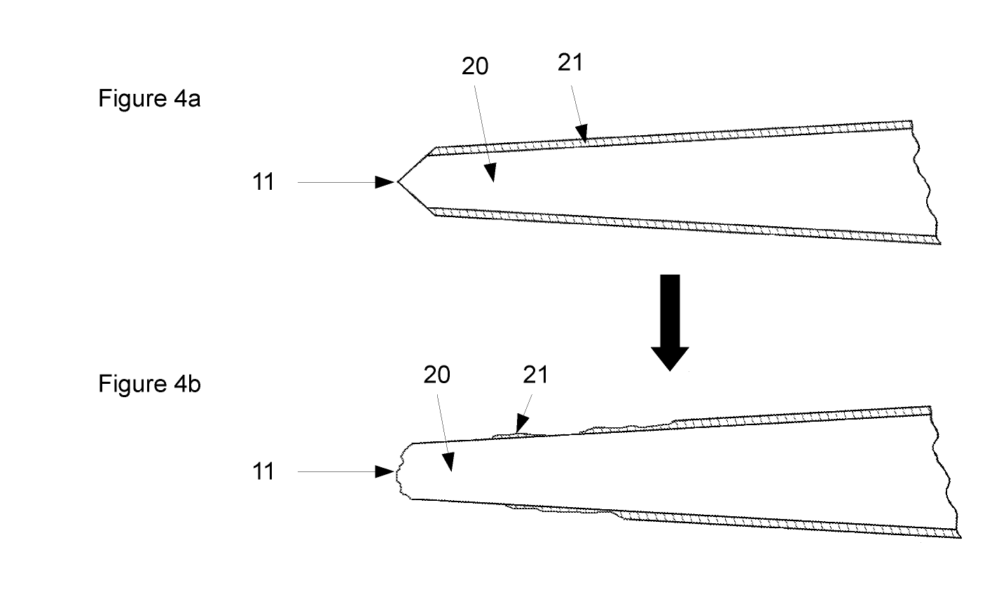

An important feature of the present invention is the careful calibration of the wear resistance and thickness of the wear layer. If the wear layer wears away too easily, the change of visual appearance of the blade may happen while the cutting edge is still suitably sharp (FIG. 3). So, the blade would be discarded without taking advantage of its remaining useful lifetime. Besides, for the reasons detailed in the introduction, if the wear layer is too strong, the wear layer may still cover the core material of the blade when the cutting edge gets unsuitably blunt. So, the user will keep using the blade and perform low quality cuts with increased force and risk of injury until the late change of visual appearance eventually happens (FIG. 4).

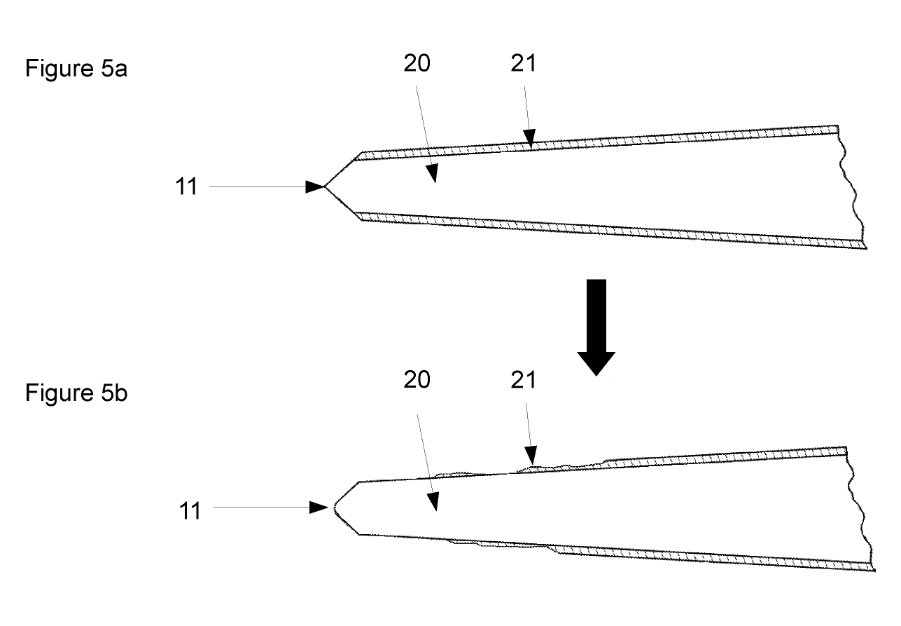

Therefore, the wear resistance of the wear layer should be smaller than the wear resistance of the core material of the blade. This way, it is possible to calibrate the thickness of the wear layer so that its disappearance occurs at the optimal moment for replacing the blade (FIG. 5), and not any sooner or later. For example, if:
the blade should be deemed dull after 50 μm of material is worn away from its cutting edge;
the wear resistance of the core material of the blade is 10 times higher than the wear resistance of the wear layer;
the abrasion on the sides 12 of the blade is 10 times less intense than on the cutting edge 11, the wear layer is selected to be 50 μm thick. If the wear layer can be deposited with a precision of 1 μm, the thickness of the wear layer is 50 μm±1 μm, i.e. 50 μm±2%. So, with a blade getting dull after approximately 5 days of use, the optimal moment for replacing the blade can be determined with an excellent precision of about one hour.

There are at least two possibilities of achieving a layered structure where the wear layer has a different visual appearance than the core layer, and a lower wear resistance. On the one hand, both core and wear layers may be made of the same material, but with structural differences that account for the different visual appearance and the lower wear resistance of the wear layer. For example, the wear layer may be formed by etching a metallic or ceramic core layer in order to make it porous down to a certain depth. The porous structure of the wear layer will then have a different visual appearance and a lesser strength than the untouched core layer. On the other hand, core and wear layers may be made of two different materials. For example, here is a non-exhaustive list of possible combinations of core material and wear layer:

| Strong core material | Weaker wear layer |
|---|---|
| Tempered steel | Regular steel |
| Ceramic | Metal |
| Metal | Weaker metal |
| Ceramic | Polymer |
| Metal | Polymer |
| Ceramic | Organic material |
| Metal | Organic material |
| Ceramic | Nanoparticles |
| Metal | Nanoparticles |

Ceramics are well known for having the best wear resistance, so they are often used as core material for high-performance blades. Metals are less resistant to wear and therefore represent suitable materials for the wear layer. In addition, ceramics and metals have very different visual appearances: polished metals have a shiny grayish color, whereas ceramics are matte, mostly white and can easily be pigmented in many different colors. A further possibility is to use two different metals, a stronger one for the core material and a weaker one for the wear layer. In this case, the layered structure may be achieved by sputtering, plating or Physical/Chemical Vapor deposition (PVD and CVD) for example. If despite their different nature, both metals still have the same visual appearance, they can be given different colors via implantation of ions. Seeding colored nanoparticles onto the surface of a metallic or ceramic core material is another possibility for making a colored wear layer. Besides, ceramic or metallic cores may be coated with various polymers like resins or various organic materials like paints. The advantage of polymers and organic materials in general is that they are cheap, easy to process and can easily be given any desired color. For example, paint is applicable at room temperature and the blade may be coated with a polymer precursor and then UV- or heat-cured.

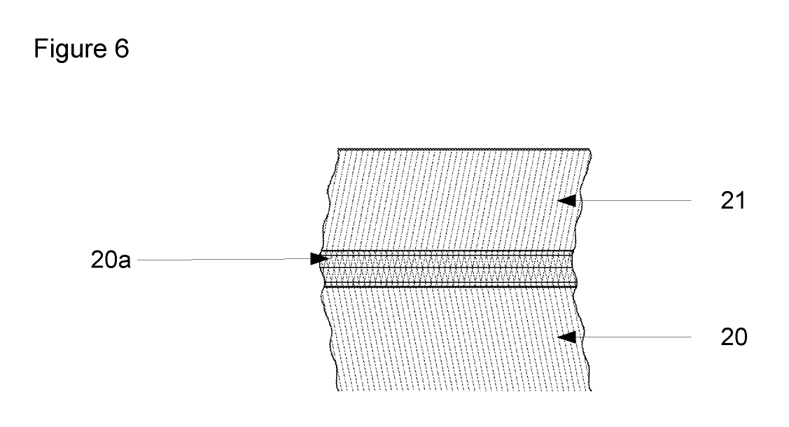

In order to create a strong direct bond between two materials, especially if they are very different, an intermediary bonding layer 20a may be required to ensure the adhesion of the wear layer 21 to the core layer 20 (FIG. 6). While two metals form mutual metallic bond easily, metallic and polymeric wear layers may bond poorly to a ceramic core material, and an organic wear layer (e.g. polymer, paint) may bond poorly to a metallic core material. So, in the case of a metallic or ceramic core material 20 which is to be coated with an organic wear layer (e.g. polymer, paint), the intermediary bounding layer 20a may be a primer. In the case of a ceramic core material which is to be coated with a metallic wear layer, the intermediary bounding layer 20a may be a porous ceramic layer. Such a layer allows the metal to infiltrate the pores and provides mechanical interlocking of the metallic and ceramic phases.über

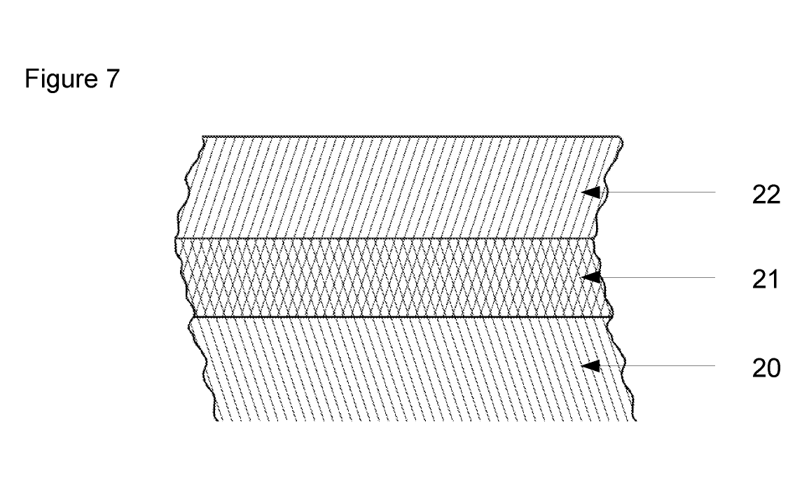

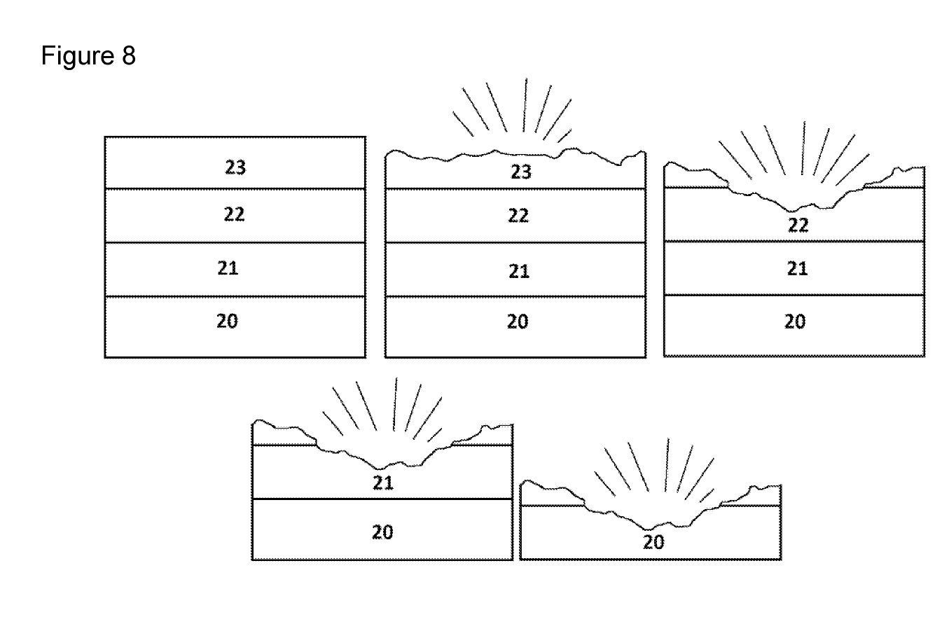

In further embodiments, the blade may not only feature one wear layer, but several stacked layers (FIG. 7-8). Thus, the erosion of the layers causes the emergence of successive different colors which indicate the severity of the erosion of the blade (FIG. 8). For example, in a possible embodiment of the invention, the outer wear layer may be gray, the second wear layer yellow, and the core material red. So, the properties (thickness, wear resistance) of each layer may be adjusted so that: the gray color corresponds to a perfectly sharp cutting edge; the yellow color to a used but still acceptably sharp cutting edge; and the red color to a critically blunt cutting edge. This allows a finer assessment of the state of erosion of the blade: the user may be instructed to change the blade as soon as the slightest shimmer of red color appears, while a limited number of yellow areas are still acceptable. Alternatively, the user may be instructed that:
a gray blade is suitably sharp for all uses;
a yellow blade is suitable for opening cardboard boxes but not for clean precision cuts;
a red blade must be replaced immediately.

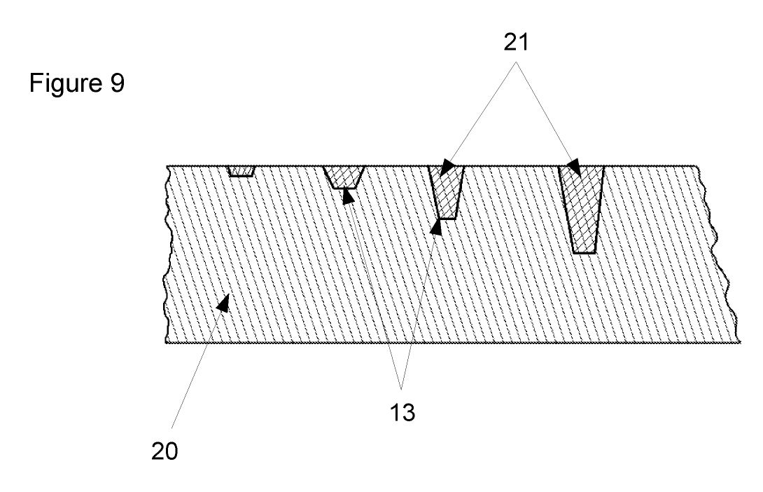

In a further embodiment of the invention, rather than locally coating the core material 20 of the blade with the wear layer 21 and therefore creating a difference in height between the coated and non-coated regions, a first step may involve creating one or several small holes or grooves 13 on the surface of the core material 20 of the blade. This can be done by conventional mechanical machining means, e.g. with a drill, a reamer, a punch, a blade or an indenter. Alternatively, a laser may be used in order to machine high-precision holes or grooves 13 in the core material. These holes or grooves 13 can have any desired shape. In a second step, these holes or grooves 13 are filled with a material building the wear layer 21. As the blade wears out, the depth of the hole or groove 13 and the thickness of the wear layer 21 continuously decreases until it eventually disappears completely, causing a visual change of appearance of the blade. The holes or grooves 13 may also be filled with several successive wear layers with different visual appearances. In a specific embodiment of the invention, the blade may be provided with a series of holes 13 of different depths, each filled with the wear layer material 21 (FIG. 9). The wear layer material 21 may have a different visual aspect for each hole, and each hole may be filled with successive wear layers having different visual aspects. Seen from above, this forms a series of colored or visually different patches on the surrounding core layer of the blade 20. As the blade wears away, the shallowest holes 13 disappear while the deepest remain. Thus, the number of remaining patches is an indicator of the severity of the erosion of the blade. For example, given a brand new blade initially featuring 3 of these patches, an operator may be instructed that:
a blade featuring 3 patches is suitably sharp for all uses;
a blade featuring 2 patches is suitable for opening cardboard boxes but not for clean precision cuts;
a blade featuring 1 patch should be monitored carefully because it must be replaced soon;
a blade where all the patches have disappeared must be replaced immediately.

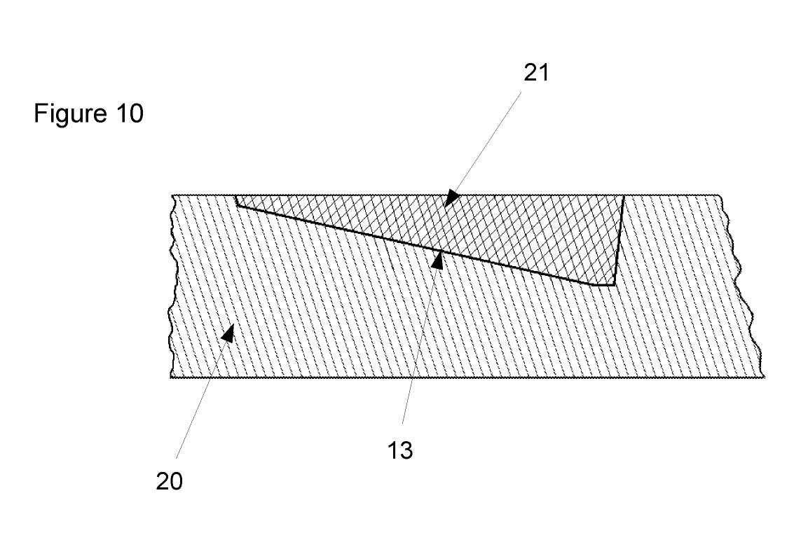

In another embodiment of the invention, the core material of the blade 20 may be provided with one or several grooves 13 of increasing depth, filled with a material forming the wear layer 21 (FIG. 10). Seen from above, this forms a colored or visually different line on the surrounding core material of the blade 20. As the surface of the blade wears away, the shallow end of the groove 13 disappears, thus reducing the length of the visually different line. For example, an operator may be instructed that the blade must be replaced when the groove 13 is shorter than a given length. In order to help the operator assessing the length of the groove 13, the core material 20 of the blade may be provided with graduation means along the groove 13, e.g. painted on the surface of the core material of the blade or carved in it.

For some uses an alternative embodiment includes a sensor, which can be included with the knife or blade holder. The sensor can be a separate device or incorporated on the blade. It can be an optical sensor which detects the color of the partially worn blade and sends a signal to the user to indicate that the blade should be replaced. The sensor could also measure the resistance of the blade, which depends on the thickness of the wear layer, to enable the precise detection if the blade should be replaced. Such an embodiment including a sensor is particularly useful in environments, where visibility is limited due to dust or other particles in the air, or when there is only limited lighting.

This description and the accompanying drawings show exemplary embodiments of the invention. The invention, however, should not be interpreted as being limited to these particular embodiments. Variations of the embodiments can be made by those skilled in the art without departing from the scope of this invention as defined by the claims.

1. A cutting blade made of a core material, consisting of
at least one cutting edge and
at least one layer covering a part of the core material
wherein
said layer
is a wear layer which has a different visual appearance than the underlying material of the blade, and
which wears away more quickly than the core material when the blade is used
thus
uncovering the underlying material of the blade as soon as it is completely removed in partial areas.

2. The blade according to claim 1,
wherein
the wear resistance of the wear layer is lower than the wear resistance of the core material of the blade.

3. The blade according to claim 1,
wherein
the uncovered underlying material of the blade provides a visual indication of the state of erosion of the blade.

4. The blade according to claim 3,
wherein
the calibration of the wear resistance and thickness of the wear layer is such that said visual indication is provided as soon as the cutting edge of the blade is no longer suitable for the intended use.

5. The cutting tool of claim 1,
wherein
several successive wear layers with different visual appearances cover the blade, in such manner that the visual appearance of the blade changes several times as the wear process goes on.

6. The blade according to claim 5,
wherein
several successive layers indicate intermediary states of erosion of the blade depending on the amount of use.

7. The blade according to claim 1,
wherein
a bonding layer is provided between two different materials to ensure proper adhesion.

8. The blade according to claim 5,
wherein
said wear layers have different thicknesses.

9. The blade according to claim 1,
wherein
the thickness of said wear layer varies according to the expected amount of wear in the different regions of the blade.

10. The blade according to claim 1,
wherein
the core material of the blade is provided with one or several grooves or holes filled with the wear layer material.

11. The blade according to claim 10,
wherein
the bottom of said groove is inclined.

12. The blade according to claim 10,
wherein
said holes have different depths.

13. The blade according to claim 1,
wherein
a sensor is used to detect the level of wear of the wear layer by optical, electrical or magnetic means.
